(19) United States
(12) Patent Application Publication
(10) Pub. No.: US 2008/0186232 A1
(43) Pub. Date: Aug. 7, 2008

(54) Method of and apparatus for true north azimuth determination using the combination of crossed loop antenna and radio positioning system technologies

(75) Inventor: Erik Johannessen, Bedford, MA (US)

Correspondence Address: RINES & RINES, 24 Warren St., CONCORD, NH, 03301, US

(73) Assignee: Megapulse, Inc.

(21) Appl. No.: 11/701,781

(22) Filed: Feb. 2, 2007

(51) Int. Cl. G01S 1/24

(52) U.S. Cl. 342/388

(57) ABSTRACT

A method and radio navigation system compass apparatus for determining true north or azimuth or orientation of a vehicle or the like by the use of integrated Loran and satellite radio navigation receivers employing crossed-loop H-field antennas for the Loran reception, or the use of at least three Loran type transmitter, or two Loran type transmitter and a synchronized clock for determining both position and azimuth.

The present invention relates generally to radio navigation systems and direction finding, being more particularly directed to determining a true azimuth or orientation through employment of signals of Loran-type ground-based navigation stations or systems as received by crossed-loop antennas, improving the utility of radio navigation information from such ground-based navigation systems or from satellite navigation systems (SNS), such as the American Global Positioning System (GPS), or combination thereof.

### BACKGROUND

The use of SNS devices for navigation of vehicles for air, marine, and land transport is well known and widely used. It is also common that such devices are used for economic or commercial purposes such as machine control, seismic and hydrographic survey, and time synchronization. These devices are highly effective at providing an indication of position referenced to a common grid system such as Latitude and Longitude, the display of which is increasingly presented in the form of electronic map displays.

In maritime electronics, for example, sensor information including but not limited to echo soundings, radar returns, weather, navigation information and the like are all presented on an electronic chart, system, typically oriented in one of two ways. In the first case, the chart is oriented such that true north is at the top center of the user display. In the second case, the information is presented “heads up”; i.e. the direction that a user is traveling is displayed as the top center. Additionally, a user's change in successive positions can be displayed as a course or heading indication, though a recognized drawback of using such successive positioning methods to determine heading resides in the limitation that at very low or zero velocities, such devices are not capable of producing a valid indication. It has been the practice, accordingly, to augment the position fixing devices with a digital magnetic compass. Magnetic compasses, however, are subject to magnetic deviation and magnetic variation effects that differ from place to place and from time to time. Magnetic deviation is the error due to the difference between the earth's magnetic and geographic (true) north poles and may be solved by compensation, knowing the current time and present location. Magnetic variation is the error due to local effects such as underground ores, or the influence from a vessel itself. A number of calibration techniques exist to minimize these influences, but such calibration techniques are by nature error prone and time consuming.

While loop antennas, including arrays involving orthogonally and otherwise relatively positioned or crossed loops, have been used for many years in myriads of radio location and direction finding systems, they have not heretofore lent themselves to Loran-C and similar navigation location signal tracking applications in view of their lack of omni-directivity of antenna pattern, carrier phase inversion characteristic, their need for the use of a pair of separate loops and associated band-pass filters and low noise amplifiers that may be involved.

A successful technique for solving this problem of lack of omni-directivity antenna pattern, is described in previous U.S. Pat. No. 5,796,366 of Megapulse, Inc., the common assignee herewith, for “Method of and Apparatus For Position Location And Tracking Of A Vehicle Or The Like By The Reception At The Vehicle Of Pulsed Radio Navigation Signals As Of The Loran C Type And The Like, With an Autonomous Loop Antenna Receiver” (Andre V. Grebnev and Jan Anderson). By comparing the received signal in each of the orthogonally crossed antenna loops, a relative bearing to the station may be calculated. Through installing the antenna with a predetermined orientation with respect to the lobes of the orthogonally crossed loop pattern, the apparatus is then able to receive a signal in each loop from the radio stations, and the signals may then be compared in such a way as to determine the bearing of the received signal. Having foreknowledge of the source radio station locations, the antenna pattern may be compared with the expected pattern at the present computed position.

The Loran system with its ground-based transmitters is regional by nature. Typically, a minimum of three Loran station signals must be received in order accurately to determine a position solution. The usefulness of Loran can be extended, however, by transmitting information superimposed upon the navigation signal. Combining this information with the information from a dissimilar navigation system, such as a satellite navigation system, is often mutually beneficial to both the ground based and satellite based services.

One method of improving the accuracy, availability, and integrity of such position determination has been described in earlier U.S. Pat. No. 5,563,611 (Edward McGann and William Roland), also of said Megapulse, Inc., for “Method of and Apparatus for the Integration of Loran-C and Satellite Navigation System (SNS) Technologies for Improved System Accuracy, Availability, and Integrity”.

In accordance with the present invention, such crossed-loop antenna techniques are used in a novel manner with such positioning system technologies, to provide a new radio compass technique that can now produce a true heading—true north azimuth when the receiver is stationary, and both heading and azimuth, when moving.

### OBJECTS OF INVENTION

An object of the invention, accordingly, is to provide a new and improved method of and apparatus for accurately indicating true north azimuth or orientation to a user of either Loran-type navigation devices or an integrated Loran and satellite navigation system (SNS) device, and that shall not be subject to the above-described prior art limitations.

A further object is to provide a novel true north azimuth determination system that includes a Loran type system having a receiver with crossed-loop antennas capable of receiving Loran signals.

Another object is to provide in the present invention, a two-axis tilt sensor that may provide orientation in three dimensions and, where desired, may include a means for calibration for improved accuracy.

Other and further objects will be explained hereinafter and are more particularly delineated in the appended claims.

### SUMMARY

In summary, however, from one of its broader aspects, the invention embraces a method of azimuth determination by a pair of orthogonally crossed individual loop antennas for receiving radio-frequency navigation signals from navigation transmitter sources, that comprises, acquiring the signals in the individual loop antennas of the pair of loop antennas along separate respective channels; comparing the acquired channel signals using their relative received field strengths to determine the relative bearing angles to the transmitter sources; and using said relative bearing angles together with the known positions of both the antennas and of the radio-frequency sources to determine the orientation of the loop antennas with respect to a geographic orientation.

This invention provides a novel radio compass system in which the output signal indication that is produced is a true heading. Loran-C navigation signal transmissions are received by a crossed loop antenna that receives the H-field signal in each channel, and wherein the phase of the signal is critical to solving for position. Knowing the present location of the antenna(s) and the location of the source signal, the antenna(s) resolves the bearing to the source signal. In a mode where integration with satellite navigation is desirable, only one Loran signal with suitable station identification maybe required. Alternatively, with a minimum of three Loran transmitters, position and azimuth are determined. As earlier described, the device, when in a stationary vehicle, provides true north azimuth; but it also is capable of providing both heading and azimuth of the vehicle when in motion. For improved accuracy, a two-axis tilt sensor is preferably employed as a means to compensate for effects of vehicle pitch and roll. The integrated device combined with a laser or similar range finder, moreover, is able precisely to determine the location of a target object.

Preferred and best mode techniques and apparatus design, details and configurations are later presented.

### DRAWINGS

The invention will now be described in connection with the accompanying drawings,

FIGS. 1 and 2 of which are antenna pattern diagrams illustrating the calculation of angles in a crossed-loop antenna system of the invention, designed for either the combination shown in FIG. 1 of a satellite navigation position solution plus the use of one Loran station, or, a three Loran position solution plus providing for the reception of a single Loran station signal for azimuth determination;

FIG. 3 is a block diagram of a Loran sensor suitable for azimuth and position functions in accordance with the present invention.

FIG. 4 is a similar diagram of an integrated satellite navigation and Loran sensor system.

FIG. 5 is a similar diagram of an integrated Loran-satellite navigation, and tilt sensor for determining azimuth and orientation;

FIG. 6 is a similar diagram that includes the addition of a range finder for azimuth, elevation, and range determination of a distant target;

FIG. 7 is an illustration of the effects of unequal gain or delay between antenna loops;

FIG. 8 illustrates the effect on phase response between a theoretically ideal loop antenna and the measured response of an actual loop antenna;

FIG. 9 is the pattern difference between a theoretically ideal loop and an actual loop antenna;

FIG. 10 is a graph that displays the effect of using a calibration curve for improvement of azimuth accuracy herein; and

FIG. 11 is a diagram illustrating means to determine the integrity of a heading determination.

### DESCRIPTION OF PREFERRED EMBODIMENTS OF INVENTION

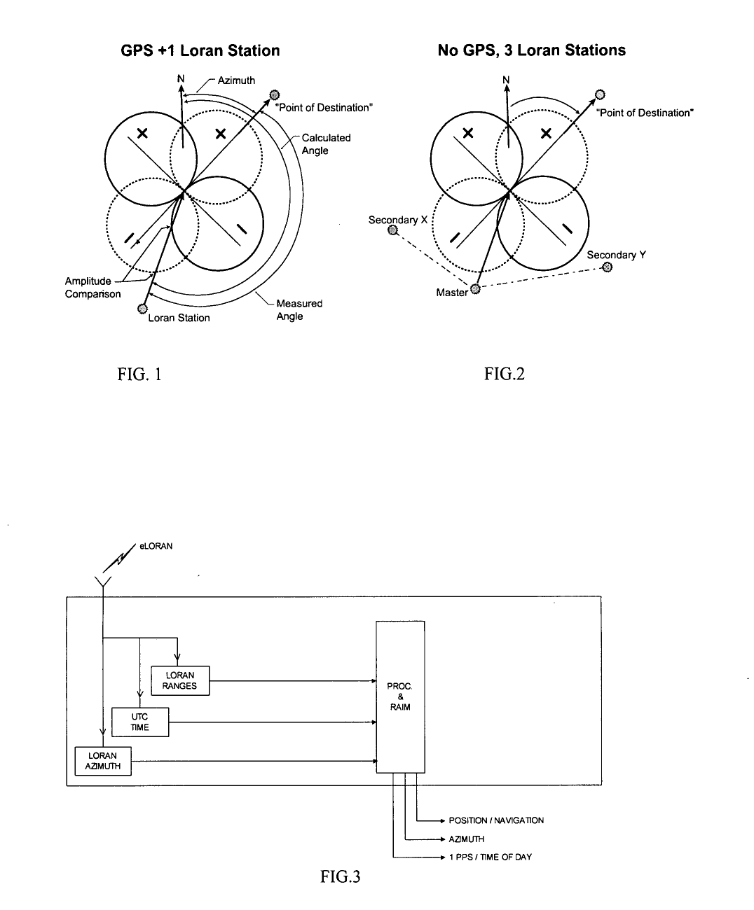

Referring to FIGS. 1 and 2 herein, the reception pattern characteristics of a loop antenna (also referred to herein as H-field antenna) is shown as a bi-directional pattern resembling a “figure eight”, in which one of the pattern lobes is “positive” (indicated by a “+”) and the other is “negative” [indicated by “−”]. The positive lobe has the same phase on the output of the loop winding as the phase of the received signal. Signals received in the negative lobe are phase inverted. To achieve an omni-directional pattern of operation, a pair of orthogonal crossed loops is used, as described, for example, in said prior U.S. Pat. No. 5,796,366 of common assignee of the present application. In the Loran application, phase errors can not be tolerated and thus it has become necessary that receivers resolve the pattern of the antenna.

As before stated, one of the preferred configurations of the invention for determining true north azimuth uses a minimum of one Loran station (so-labeled in FIG. 1) combined with a satellite navigation system (SNS) position fix as shown. In practice, a crossed loop antenna housed within a mechanical enclosure is used, schematically represented at L, and preferably having the ferrite construction described in said U.S. Pat. No. 6,014,111 (Paul R. Johannessen) of common assignee herewith, for achieving miniaturization. An indicator of the alignment is provided external to the enclosure; e.g. by an arrow that allows a user to point the antenna L in a forward direction. An SNS antenna may be located on top of the crossed loop antenna L. The SNS receiver (not shown) determines location by analysis of the SNS signals in well known fashion. The Loran receiver (also not shown) receives signals from a “Loran Station” transmitter source the coordinates of which are known. In the case that the Loran transmitter is designated as a “Master” within its chain, the receiver can uniquely identify the station by the Group Repetition Interval and the phase code, as is also well known. In the case that the Loran signal originates from a secondary Loran transmitter source, then a means to identify the station, such as a Eurofix message having modulated data on the Loran signal, may be used, as is also known.

With knowledge of the geographic location of the user and the geographic location of the transmitted Loran signal source, a “Calculated Angle”, so labeled in FIG. 1, can be determined with respect to the antenna pattern. The amplitude or field strength of the received Loran signal in each of the crossed loop pairs is measured in accordance with the invention, and compared, resulting in a “Measured Angle”. The difference between the calculated and the measured angle is the deviation from true north, “N”, or azimuth, and is an indication of the user's orientation towards the “Point of Destination” shown in FIG. 1.

In FIG. 2, the system uses only Loran navigation signals, such as where insufficient SNS (GPS) signals are available to determine location. The Loran receiver receives signals from the conventional three or more Loran station navigation signal sources whose coordinates are known—the “Master” and “Secondary X” and “Secondary Y” of FIG. 2. The receiver is capable of calculating the vehicle location of the user and identifying the location of the signal sources. By performing an “Amplitude Comparison” on any one or more of the signals, as in FIG. 1, the azimuth can be determined. It is preferable to use the signal with the highest signal or field strength for improved accuracy. The art also sometimes uses a subset of Loran, operating in a specialized mode referred to as the Rho-Rho mode, wherein only two Loran stations are required, used with a well synchronized clock to calculate position in an equivalent manner. Azimuth determination is the same as for the three station case.

The invention thus permits use and realization in several configurations—, all however, realized from crossed loop antenna reception of Loran, with or without SNS or other additional sensors, as shown in FIGS. 3-6. The most basic implementation, however, is a so-called Type I configuration of FIG. 3. This is referred to as a Loran-only solution, described also in connection with FIG. 2.

Modernized or enhanced Loran systems are commonly referred to as “eLoran”. The two principal differences between Loran-C and eLoran systems are the use of all-in-view receivers, and the addition of a data channel. All-in-view receivers are enabled by synchronizing all transmitters to a common time scale for time of transmission control as described, for example, in U.S. Pat. No. 4,791,422 (Robert B. Goddard), of common assignee herewith. One example of a data channel implemented on the Loran signal is described in earlier mentioned U.S. Pat. No. 5,563,611.

Referring specifically to FIG. 3, the eLoran signal is received in the crossed loop antenna L and processed conventionally by a controller in the Loran receiver R_{L} to measure time of arrivals or ranges for all stations in view, and demodulating a message containing time of day information, and, also in accordance with the invention, performing the azimuth calculation. The receiver controller processes the “Range”, “Time”, and “Azimuth” information so that as the user equipment moves, it indeed provides the practical functions of navigation. The controller also can provide a means to exclude individual Loran stations if any received signal is measured to have erroneous azimuth or signal data, or if the data channel message carries a warning. The controller, for example, may be an integrated circuit such as a Digital Signal Processor (DSP) and Field Programmable Gate Array (FPGA), or Application Specific Integrated Circuit (ASIC). Alternatively, it may be a general purpose computer.

The output of the controller is a set of messages that may be formatted according to the application. As illustrations, the messages may be according to the National Marine Electronics Association (NMEA) standard, permitting interconnection to devices such as electronic chart systems or autopilots.

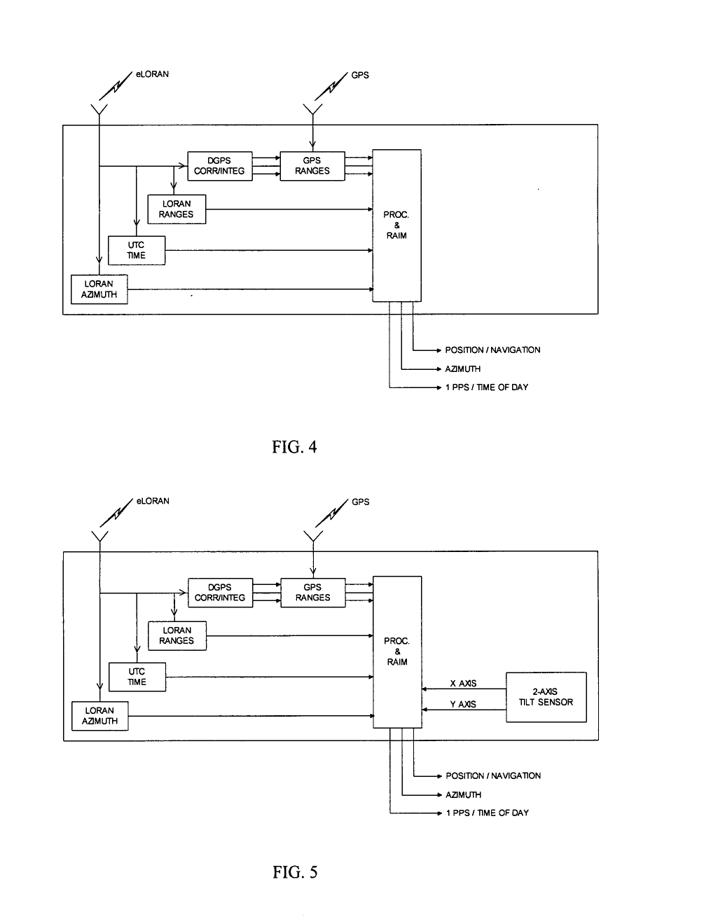

In a Type II configuration of the invention illustrated in FIG. 4, the SNS (GPS) receiver is added to the eLoran, thus creating an integrated SNS/Loran receiver R_{L}/_{GPS}. A particularly suitable integrated receiver is the Model “eLoran” of the assignee of the present application. That embodiment utilizes an active SNS antenna and SNS chipset. In other embodiments, the SNS receiver could be separately housed or may be fully integrated at the chip level or other vehicle. The addition of the SNS allows a single Loran station, as in FIG. 1, to be used for azimuth determination, thereby significantly extending the coverage area and utility of the Loran system.

The accuracy of the azimuth measurement is dependent upon several factors including, but not limited to, the heading/station-angle combination, antenna quality, mounting misalignment and effects of pitch and roll. In a Type III configuration shown in FIG. 5, accordingly, a two axis “Tilt Sensor” is added to the integrated SNS and Loran receiver R_{L}/_{GPS}. The Tilt Sensor or inclinometer may be one of many types such as Solid State MEMS, fluid filled, or force balanced. The tilt sensor is mounted such that the X and Y axes have a known relationship to the axes of the crossed loop antenna L. The azimuth accuracy is improved by the processor, which corrects for the heading dependent variations caused by tilting the crossed loop antenna. Thus, for example, a user that has mounted the antenna on a sailboat mast, for example, is able to determine azimuth as if the crossed loop antenna were constantly maintained in a fixed horizontal plane.

The Types I-III configurations of the invention thus allow a user to determine true north azimuth in addition to the traditional information of position and time. This is also a useful capability in a dependent surveillance system such as the maritime Automatic Identification System (AIS).

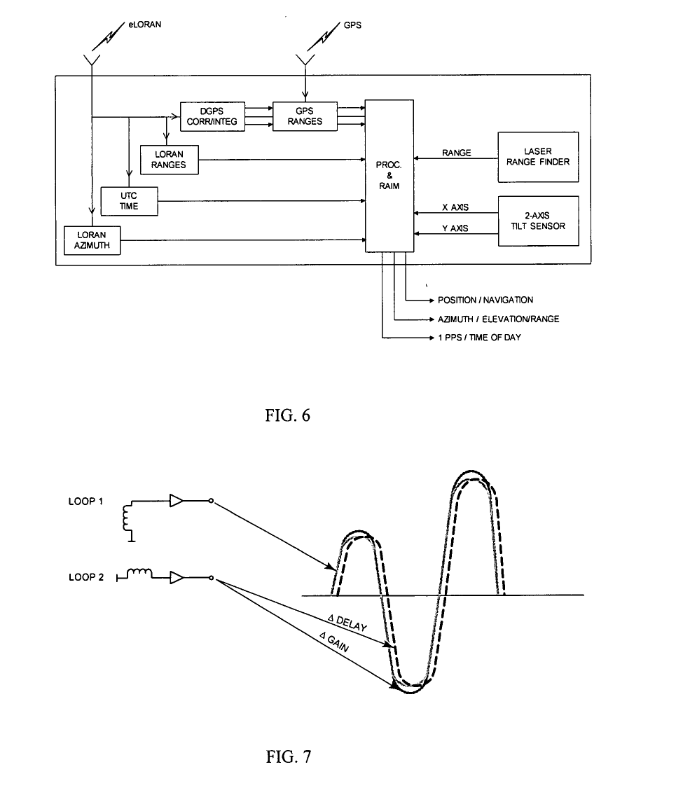

Another useful configuration of the invention is a Type IV presented in FIG. 6. The integrated SNS/Loran receiver _{RL}/_{GPS} with tilt sensor of FIG. 5 is mechanically attached to an instrument capable of measuring distance from an observer to a target, such as a laser or other optical range finder (including monocular, telescopic and gun sights etc.) The processor calculates the present position, a highly accurate azimuth, elevation, and range to the target, and is thus able precisely to determine the position of the target object. The present invention is not limited, however, to use with a laser rangefinder, as other methods such as sonar, radar, or electronic distance measurement devices are also applicable.

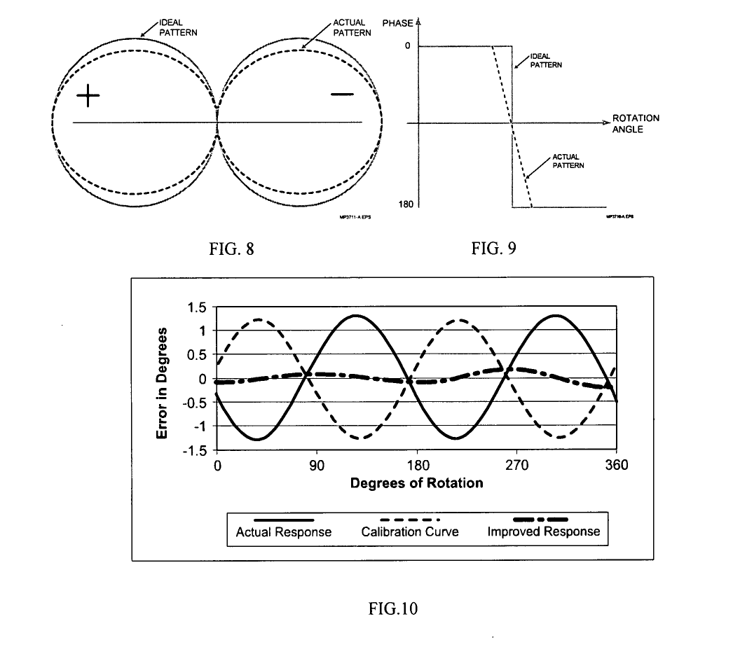

The Type IV configuration of FIG. 6, however, in order to be most useful, requires azimuth accuracies higher than that required in the systems of Type I (FIG. 3) or Type II (FIG. 4). Ideally, a crossed loop antenna would have a theoretically perfect response, but it is more cost effective to manufacture an antenna using best practices and then perform additional calibration in hardware, firmware, or processor software. FIGS. 7-10 (illustrate such) techniques for compensation of heading-dependent errors in the present invention.

Two orthogonally oriented loops are shown as L₁ and L₂ in a simplified schematic in FIG. 7, herein. Loop 1 produces a Loran waveform (solid line) with a highly stable and fixed delay in response to a signal injected into the loop. Slight variations in the manufacture between Loop 1 and Loop 2 may, however, result in Loop 2 responding with a slightly different delay or gain as a “ΔDELAY” an “ΔGAIN” (dotted-line waveform). This leads to azimuth variations when the loop amplitude comparison is performed, either by comparing half cycle pulse peaks or by comparing values obtained in sampling through the pulse.

As before mentioned, the theoretical pattern for a single loop antenna resembles a “figure eight”, wherein each lobe is circular and the null has infinite depth. This is indeed nearly the case in the prior art use of large air core loops. In order to achieve the small form of the present invention, however, ferrites are preferably used, as earlier described and as taught in the earlier cited patent references. The actual pattern is typically slightly elliptical and with incomplete nulls. This results in a phase transition with less than infinite slope that causes degradation of the positional and azimuth determination accuracies. The present invention, therefore, incorporates into the processor shown in any of the Type I-IV configurations, a means to store a calibration curve as depicted in representational form in FIG. 10. An individual crossed loop antenna can be measured via automated test equipment to generate an actual response curve. Based on the measured actual response, a calibration curve is then selected, stored in the user equipment memory, and applied as a correction by the processor with resultant improved response accuracy of azimuth determination. In another embodiment of the present invention, the user equipment is able to measure the actual response and automatically select an appropriate calibration curve.

Such calibration will compensate for the natural signal reception effects of a crossed loop antenna. Additionally, a means may be provided in the invention to compensate for two further common Loran system phenomena. The first is an offset of geographic position due to uncertainties of low frequency (LF) propagation over land. The second is re-radiation of the signal off extremely large structures in the vicinity.

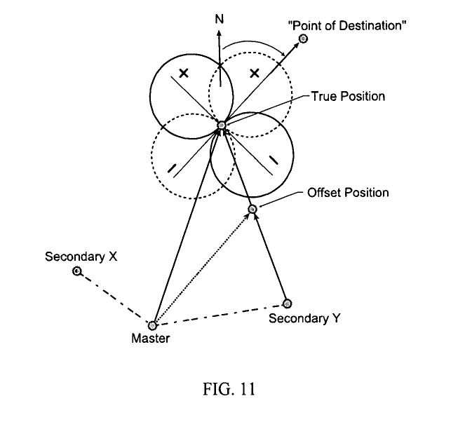

Turning, accordingly, to FIG. 11, (which is not drawn to scale), it is seen that the error in azimuth determination is dependent upon the selection of station used for the angle measurement. For the Type II configuration, the Loran propagation uncertainties are cancelled by the calibration using the SNS fix. In the Type I configuration, however, as the distance from the transmitter used for angle measurement decreases, the potential error in azimuth increases. The user equipment therefore, in accordance with the present invention, may make multiple angle measurements and combine them in a weighting scheme for improved accuracy. Further, the receiver is enabled to determine the probable fix accuracy based on the Horizontal Dilution Of Precision (HDOP) of the stations used for position determination. The present invention thus determines and provides an indication to the user of the quality of the azimuth measurement and allows the user to set an alarm limit when the user equipment-predicted error exceeds the user defined limit. The azimuth determination is improvable, furthermore, through differential corrections of either the satellite or the Loran signals (before cited U.S. Pat. No. 5,563,611).

As for signal re-radiation off nearby large structures, such is affected by the size of the structure, the direction of travel of the signal, and the orientation of the user with respect to the re-radiator, and thus will not affect all angle measurements equally. Where multiple transmitters can be received, however, the invention may calculate an over-determined solution and exclude signals that are re-radiated. As re-radiation can also affect the accuracy and integrity of the position solution, an indication of the excluded signal may also be provided to the user.

While the invention has been described in connection with the preferred Loran-C operation, the techniques of the invention are also useful with other pulsed navigation and related systems; with other LF, MF, and shortwave signals where the use of conventional loop antennas is common; and other H-type antennas than the preferred ferrite crossed loop type of the invention (all generically called “loop antennas” herein) may also be similarly used; and further modifications will occur also to those skilled in the art, all such being considered to fall within the spirit and scope of the invention as defined in the appended claims.

What is claimed is:

1. A method of azimuth determination by a pair of orthogonally crossed individual loop antennas for receiving radio-frequency navigation signals from navigation transmitter sources, that comprises, acquiring the signals in the individual loop antennas of the pair of loop antenna along respective separate channels; comparing the acquired channel signals using their relative received field strengths to determine the relative bearing angles to the transmitter sources, and using said relative bearing angles together with the known positions of both the antennas and of the radio-frequency source to determine the orientation of the loop antennas with respect to a geographic orientation.

2. A method as claimed in claim 1 and in which the radio-frequency signals are navigation signals of the Loran-C type and wherein one or more of the signals is from a master Loran station transmitter.

3. A method as claimed in claim 1 and in which the radio-frequency signals are navigation signals of the eLoran or Eurofix type and wherein the source of the signal can be determined by station identification in a data channel message thereof.

4. A method as claimed in claim 2 and in which the position of the crossed loop antenna is determined using a minimum of three Loran navigation signals, and orientation is determined by one or more of the Loran signals.

5. A method as claimed in claim 2 and in which the position of the crossed loop antenna is determined using a minimum of two Loran navigation signals plus an external clock source, and orientation is determined by one or more of the Loran signals.

6. A method as claimed in claim 3 and in which the position of the crossed loop antenna is determined using a second set of radio-frequency signals for position determination such as satellite navigation signals, and wherein orientation is determined by one Loran signal.

7. A method as claimed in claim 1 and in which, the accuracy is improved by incorporating and responding to a two-axis tilt sensor to compensate effects of pitch and roll.

8. A method as claimed in claim 7 and in which, the accuracy is further improved by compensating for the difference between a theoretical perfect loop antenna response and the actual measured antenna response.

9. Radio-frequency apparatus for azimuth determination having, in combination, a Loran-C or eLoran navigation receiver employing a crossed loop antenna with a microprocessor to determine position, to identify the received stations, and to determine relative heading of the antenna so as to provide an indication of azimuth.

10. Radio-frequency apparatus for azimuth determination having, in combination, an integrated radio navigation receiver capable of receiving and processing radio-frequency signals from both Loran-C or eLoran navigation signals and from satellite navigation signals and employing a crossed loop antenna for the Loran signals together with a microprocessor to determine position, to identify the received signals, and to determine relative heading of the antenna so as to provide an indication of azimuth.

11. Radio-frequency apparatus as claimed in either claim 9 or 10 and in which a display provides position information from either or both of the Loran and satellite navigation signals, and azimuth information from the crossed loop antenna.

12. Radio-frequency apparatus as claimed in claim 11 and in which, azimuth is determined from a single Loran station uniquely identified via demodulation of a station identification message and wherein position is determined by satellite navigation position signals.

13. Radio-frequency apparatus as claimed in claim 10 and in which azimuth determination is improved through differential corrections of either the satellite or Loran signals.

14. Apparatus as claimed in claim 10 and in which, the accuracy of the azimuth determination is further improved by storing in the microprocessor the measured antenna pattern to compensate for heading-dependent differences between a theoretically perfect antenna and the measured antenna.

15. Apparatus as claimed in claim 14 and in which the accuracy and utility is further improved by the addition of a two-axis tilt sensor the output of which is connected to the microprocessor to compensate for heading-dependent differences due to pitch and roll.

16. An apparatus as claimed in claim 15 wherein an enclosure contains the crossed loop antenna, the two-axis tilt sensor, and the integrated Loran and satellite navigation receivers.

17. An apparatus as claimed in claim 14 wherein said enclosure is mounted in alignment with a rangefinder.
